(19) United States
(12) Patent Application Publication
(10) Pub. No.: US 2020/0206060 A1
(43) Pub. Date: Jul. 2, 2020

(54) DEVICE FOR PASSIVE THERAPEUTIC EXERCISE

(71) Applicant: Simona Tolarová, Minneapolis, MN (US)

(72) Inventor: Eduard Zelezny, Prague (CZ)

(21) Appl. No.: 16/812,303

(22) Filed: Mar. 7, 2020

Related U.S. Application Data
(63) Continuation-in-part of application No. 15/501,803, filed on Feb. 3, 2017.

(30) Foreign Application Priority Data
Aug. 6, 2014 (CZ) PV 2014-533

(51) Int. Cl. A61H 1/02

(52) U.S. Cl. CPC A61H 1/0266; A61H 2209/00; A61H 2201/50; A61H 2201/164

(57) ABSTRACT

A pedal (2) for swinging motion of a foot is pivotally mounted on a swinging shaft (4) which extends from a side wall of a drive housing (1), a drive mechanism (7) is arranged in the drive housing (1) and creates a forced swinging movement of the pedal (2) around the axis (3) of the swinging shaft (4), the axis (3) of swinging of the pedal (2) is arranged under the upper contact surface (11) of the pedal (2) and under the intersection of a vertical a with the upper contact surface (11) of the pedal (2), created by perpendicular projection of the ankle joint (10) to the pedal (2) so that the movement of the foot (12) is realized around the outer diameter of a circle having a centre in the axis (3) of swinging of the pedal (2). The drive housing (1) may be provided with outriggers (8) for adjusting the inclination towards the base (9).

### CROSS-REFERENCE TO RELATED APPLICATIONS

The present application is a continuation-in-part application which claims the benefits of and is based on U.S. application Ser. No. 15/501,803 filed on Feb. 3, 2017, which is a National Stage Application and further claims the benefits of and is based on International Application No. PCT/CZ2015/000086 filed on Aug. 5, 2015, which further claims benefit of Czech Application No. PV 2014-533 filed on Aug. 6, 2014, the disclosures of which are hereby incorporated by specific reference thereto.

### FIELD OF TECHNOLOGY

The invention relates to a device for passive therapeutic exercise, especially for plantar and dorsal flexions of lower limbs, which comprises at least one pedal for swivelling motion of the foot, pivotally mounted on the swinging shaft.

### CURRENT STATE OF TECHNOLOGY

In the civilized world of today a deep vein thrombosis becomes a new epidemic, which means that blood clots, thrombi, are formed in deep veins in the thigh and particularly in the popliteal part of the leg. In many cases, this situation results in serious life threatening complication, pulmonary embolism, in which thrombi penetrate with the blood to the lungs, where they clog small arteries, and thereby prevent the blood flow and oxygenation. The reason for thrombus formation is the lack of exercise by people with predominantly sedentary lifestyle. When moving the lower limbs muscles pump blood in the veins to the heart, and unless these muscles are in motion, blood circulation in the extremities slows down, which creates a major risk factor for thrombus formation.

Research conducted in people at risk of venous thromboembolism showed that the current use of electro-mechanical devices that cause muscle contraction significantly reduces the risk of DVT. These devices stimulate leg and thigh muscles and thus accelerate the venous blood flow, which leads to a better dispersion of activated blood components and dissolution of small thrombi. Such devices are mainly used for patients lying after injury.

However, not only lying patients but a far greater number of healthy people, who sit at work, such as IT workers, office workers, computer gamers, etc., are at risk to health and life due to the formation of clots n deep veins, and predominantly in the popliteal part of legs and thighs. It was found out that every hour of sitting, which decreases blood flow to the rear side of the knee, increases the risk of thrombus formation by ten percent.

A wide range of devices with pedals powered by pedalling or electrically are known, which cause movement of the legs. The movement of the leg on a pedal is dual; first, primary, rotating around the axis of rotation of the crank bearing pedals and secondary, rocking movement around a pivot axis of the pedal crank. However, persons sitting at work hardly use these devices, partly because the vertical movement of the leg occupies a greater height that the height of the worktop and party because movement of the leg is transferred to the upper body thus preventing work by hands, e.g. with a keyboard and a mouse.

Persons who work mainly in a sitting position, such as IT staff, administrative works, cashiers in supermarkets, are due to immobility of the lower limbs threatened not only by atrophy of muscles but especially by blood clothing resulting in formation of pulmonary embolism or heart attacks. To avoid these problems it is necessary to exercise the legs by feet motion, i.e. plantar and dorsal flexions, always after one or two hours of sitting.

Various devices are known to simulate the movement of the leg in order to exercise the muscles. They support the leg by a pedal that defines the movement. Currently known devices have pedals performing rotary motion similarly as the bicycle pedals. Some are driven by an electric motor, others by pedalling. A disadvantage of these known devices is on the one hand the range of motion of a pedal, which is so large that the exercise cannot take place under the desk, so these devices cannot be used where they are needed, i.e. during sedentary work, and on the other hand, even with such a large movement of the leg the needed plantar and dorsal flexions are very small.

The literature also mentions a device, which sets muscles of the leg in motion by electric shocks with electrodes attached to the calf and thigh, while this motion is regulated and measured by a rocking pedal that uses spring to create resistance of the muscle movement. These shocks are achieved and controlled by switch-boards placed near the leg. The disadvantage of this and other know devices is that they cannot be used where they are needed, i.e. in sedentary work, since it is impossible for a working person to expose himself/herself to electric shocks at regular intervals and always strip for this purpose and fasten electrodes to the legs or even wear them for the whole working hours.

### SUMMARY OF THE INVENTION

The device for passive therapeutic exercise according to the invention comprise at least one pedal for swivelling motion of a foot, the pedal arranged on the side wall of a drive housing and pivotally mounted on a swinging shaft extending from a side wall of the drive housing, the swinging shaft coupled with a drive mechanism arranged in the drive housing to create a forced movement of the pedal around the axis of the swinging shaft, the pedal having an upper contact surface whereas the axis of swinging of the pedal is arranged under the upper contact surface of the pedal and under the intersection of a vertical a with the upper contact surface of the pedal created by perpendicular projection of an ankle joint of a foot to the pedal, the contact surface of the pedal creating support of the foot for a movement of the foot around the outer diameter of a circle having a centre in the axis of swinging of the pedal. The swinging shaft axis may be advantageously arranged perpendicularly to the longitudinal axis of the pedal movable along a circular arc centred on the ankle joint. Preferably the drive housing may be provided with outriggers to adjust the inclination of the drive housing towards the base. The device for passive therapeutic exercise may advantageously include a mechanism to switch operations on and off as well as to regulate the size of range and speed of the pedal swinging.

The inventive device is based on rigorous and widely cited study that demonstrates that passive, i.e. externally controlled movement of feet determined by plantar and dorsal flexions significantly prevent the incidents of thrombosis and related complications. It was proved that stimulation of leg muscles, which pump blood, does not require any pedalling force, however only movement but not the vertical movement of the lower leg but only the rocking movement of the foot, i. e. plantar and dorsal flexions as a primary motion. The inventive device used by a seated person best stimulates natural gait, in which leg muscles pump enough blood and thereby prevent formation of life-threatening blood clogs without disturbing the user from focusing on work.

The inventive device consists of a housing and one or two pedals and it is arranged so that the pedals in a form of plates with dimensions corresponding to the dimensions of the feet are placed with the swing towards the housing. To drive the pedals the device is provided with a drive mechanism, in particular electric motor, connected with the pedals via kinetic mechanism arranged in the housing of the device. The swing angle is between 0° and 50°. The angle between plantar and dorsal flections shall be split by moving the device closer or further from a seated person. In order to split the angle between the plantar and dorsal flexions the device is provided at its ends with height-adjustable supports. Pedal swinging axis is located closer to the heel end of the pedal, in particular in one quarter of the length of the pedal so as it is approximately below the ankle joint. The device is further equipped with a mechanism for switching the activities on and off as well as for regulation of the size of the range and speed of the pedals rocking. Buttons to start and end the activities and to control the time and speed of swinging are arranged on the housing of the device and/or on a separate remote control. The remote control can be adapted for connection to a computer.

The advantage of the device is that it achieves the required plantar and dorsal flexions without affecting the upper torso, while it can be placed under a working desk and operated during sedentary work.

### BRIEF DESCRIPTION OF DRAWINGS

The inventive device is explained in the drawings, in which

FIG. 1 is a side perspective view of the device

FIG. 2 is a diagram of a drive mechanism

FIG. 3 is a layout of arrangement of the pedal opposite to the ankle.

### EMBODIMENT

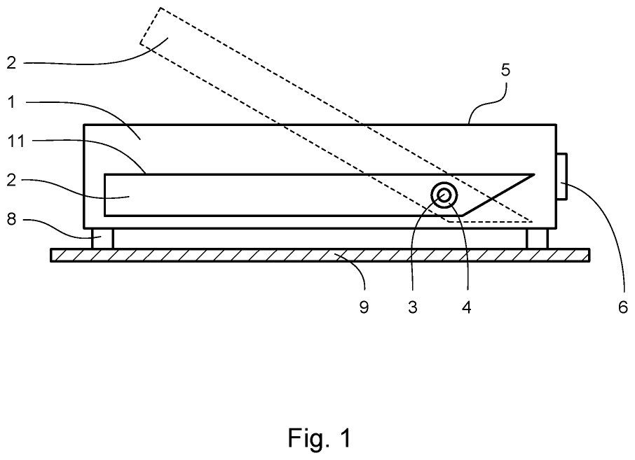

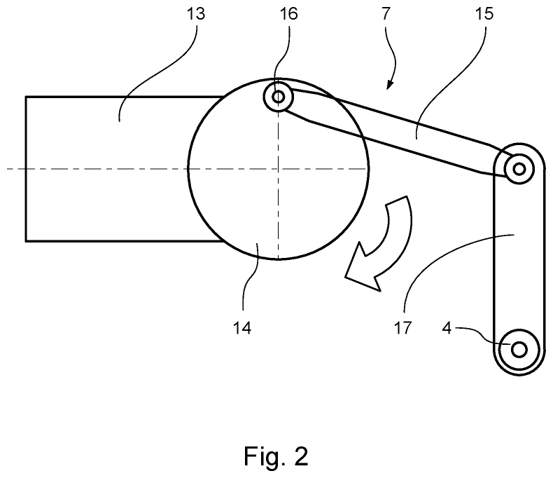

The inventive device for plantar and dorsal flexions is shown on the attached FIG. 1 where at least one pedal 2 is arranged on side wall of the drive housing 1 on the swinging shaft 4 and oscillates around the axis 3. The drive housing 1 is provided with outriggers 8 for adjusting the inclination of the drive housing 1 towards the base 9 and contains the drive mechanism demonstrated in the FIG. 2, including an electric motor 13 to drive the swinging shaft 4 firmly connected with the pedals 2. The pedal 2 is arranged on the side wall of a drive housing 1 and pivotally mounted on a swinging shaft 4 extending from a side wall of the drive housing 1, the swinging shaft 4 is coupled with a drive mechanism 7 arranged in the drive housing 1 to create a forced swinging movement of the pedal 2 around the axis 3 of the swinging shaft 4.

According to the FIG. 1 the drive housing 1 is provided with a lid 5. For easy operation the inventive device is provided on its front side with a switch 6, in particular on the drive housing 1 to supply the kinetic mechanism with the electric current. The switch is preferably located so that the current supply can be operated by legs without the need to bend down under the table. A remote control is part of the inventive design, which can be placed within the reach of the user, e.g. on the desk. A remote control is preferably adapted for connection with a computer, e.g. by USB port in order to control the device directly from the computer the user is working at. After switching on the power supply using the switch 6 on the drive housing 2 the remote control controls activity of the inventive device, mainly the beginning and the end of operation, the length of activity and frequency of plantar and dorsal flections.

According to FIG. 2 the drive mechanism 7 is arranged in a drive housing and consists of an electrical motor 13 with an output swinging shaft provided with a disc 14. A swinging bar 15 is connected at one end with the eccentric 16 of the disc 14 and at the other end with the end of other swinging bar 17 connected with the swinging shaft 4 and swinging around the axis of the swinging shaft 4 and propelling the swinging shaft 4.

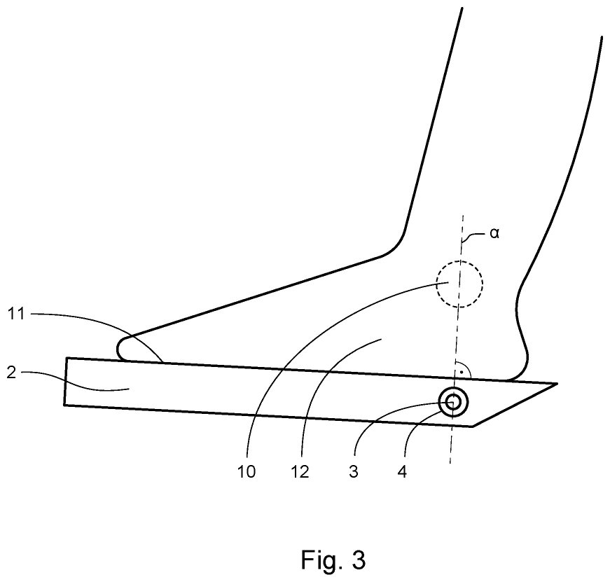

As demonstrated in the FIG. 3 the pedal 2 has an upper contact surface 11 whereas the axis 3 of swinging of the pedal 2 is arranged under the upper contact surface 11 of the pedal 2 and under the intersection of a vertical a with the upper contact surface of the pedal 2 created by perpendicular projection of an ankle joint 10 of a foot 12 to the pedal 2. The contact surface 11 of the pedal 2 creates support of the foot 12 for a movement of the foot 12 around the outer diameter of a circle having a centre in the axis 3 of swinging of the pedal 2. According to FIG. 3 the foot with the ankle 10 is placed on the pedal 2 which swings around the swinging shaft 4 with the axis 3.

1. Device for passive therapeutic exercise, especially for plantar and dorsal flexions of lower limbs, having one pedal (2) for swinging motion of a foot, the pedal (2) arranged on the side wall of a drive housing (1) and pivotally mounted on a swinging shaft (4) extending from a side wall of the drive housing (1), the swinging shaft (4) coupled with a drive mechanism (7) arranged in the drive housing (1) to create a forced swinging movement of the pedal (2) around the axis (3) of the swinging shaft (4), the pedal (2) having an upper contact surface (11) whereas the axis (3) of swinging of the pedal (2) is arranged under the upper contact surface (11) of the pedal (2) and under the intersection of a vertical a with the upper contact surface (11) of the pedal (2), created by perpendicular projection of an ankle joint (10) of a foot (12) to the pedal (2), the contact surface (11) of the pedal (2) creating support of the foot (12) for a movement of the foot (12) around the outer diameter of a circle having a centre in the axis (3) of swinging of the pedal (2).

2. The device according to claim 1, wherein the drive housing (1) is provided with outriggers (8) for adjusting the inclination of the drive housing (1) towards the base (9).
